(19) United States
(12) Patent Application Publication
(10) Pub. No.: US 2023/0153068 A1
(43) Pub. Date: May 18, 2023

(54) ELECTRONIC APPARATUS AND CONTROL METHOD THEREOF

(71) Applicant: SAMSUNG ELECTRONICS CO., LTD., Suwon-si (KR)

(72) Inventors: Bumkwi CHOI, Suwon-si (KR); Daesung LIM, Suwon-si (KR); Sunbum HAN, Suwon-si (KR)

(73) Assignee: SAMSUNG ELECTRONICS CO., LTD., Suwon-si (KR)

(21) Appl. No.: 17/425,216

(22) PCT Filed: Jul. 7, 2021
(86) PCT No.: PCT/KR2021/008631

§ 371 Date: Jul. 22, 2021

(30) Foreign Application Priority Data
Aug. 21, 2020 (KR) 10-2020-0105273

(51) Int. Cl. G06F 7/523; G06F 5/01

(52) U.S. Cl. CPC G06F 7/523; G06F 5/01

(57) ABSTRACT

An electronic apparatus is provided. The electronic apparatus includes: an input interface; a memory configured to store a plurality of weights corresponding to an artificial intelligence model; and a processor configured to perform a neural network computation with respect to input data provided through the input interface based on the plurality of weights. The processor is also configured to, based on any one or any combination of the input data, the plurality of weights, and a computation result obtained in a process of performing the neural network computation being within a threshold range, change an original value within the threshold range to a preset value and perform the neural network computation based on the preset value.

### TECHNICAL FIELD

The disclosure relates to an electronic apparatus and a control method thereof. More particularly, the disclosure relates to an electronic apparatus that performs a neural network computation on input data based on an artificial intelligence model and a control method thereof.

### CROSS-REFERENCE TO RELATED APPLICATION(S)

This application claims benefit of priority to Korean Patent Application No. 10-2020-0105273, filed on Aug. 21, 2020, in the Korean Intellectual Property Office, the disclosure of which is incorporated by reference herein in its entirety.

### BACKGROUND ART

Recent display devices support 8K (7680×4320) resolution, which is higher than 4K (3840×2160) resolution. However, there are many cases that a resolution of a previously produced image source is less than 2K (1920×1080) resolution.

A display device supporting a high resolution may upscale an image source to a resolution corresponding to a resolution of the display device when a low resolution image source is input. For example, as shown in FIG. 1, a display device may improve an image quality of an image signal such as noise reduction, detail enhancement, contrast enhancement, or the like for a low resolution image source, and upscale to a resolution corresponding to the resolution of the display device.

The display device may improve the image quality through Deep Learning Super Resolution (DLSR), and convert and output a frame rate to correspond to a display panel.

The DLSR may obtain detail information through a deep neural network consisting of a multi-layer perceptron by receiving a YUV or RGB image source, and obtain an input image (YUV or RGB) with improved detail by adding detail information to the input image (YUV or RGB).

The perceptron, which is a core structure of a deep artificial neural network computation, may include various circuit configurations. FIG. 1C illustrates an example of the perceptron that is a core structure of the deep artificial neural network computation. The perceptron may include multiply and accumulate unit (MAC) that multiplies and accumulates an input signal by a weight, an adder that adds a bias and an output of the MAC, and an activation function. FIG. 1D illustrates a hardware perceptron in which a total of m input signals and weights are input.

The MAC constituting the perceptron, the adder, and the configuration performing the activation function all consume power, and the power consumption may increase exponentially depending on a resolution of an image source. Therefore, there is a need to solve a problem of heat generation and a decrease in processing speed due to power consumption.

### DISCLOSURE

### Technical Solution

According to embodiments of the disclosure, an electronic apparatus includes: an input interface; a memory configured to store a plurality of weights corresponding to an artificial intelligence model; and a processor configured to perform a neural network computation with respect to input data provided through the input interface based on the plurality of weights. The processor is configured to, based on any one or any combination of the input data, the plurality of weights, and a computation result obtained in a process of performing the neural network computation being within a threshold range, change an original value within the threshold range to a preset value and perform the neural network computation based on the preset value.

The preset value may be 0.

The processor may be further configured to obtain the threshold range based on a result of the neural network computation using the preset value and a result of the neural network computation performed using the original value.

The threshold range may be within a range from −a to a, and a may be a positive number less than a maximum value of at least one of the input data, the plurality of weights, or the computation result obtained in a process of performing the neural network computation.

The processor may be further configured to: based on any one or any combination of the input data, the plurality of weights, and the computation result being within a first threshold range greater than the threshold range, change the original value within the first threshold range to one of a plurality of first representative values, and perform the neural network computation based on a changed value corresponding to the one of the plurality of first representative values, and based on any one or any combination of the input data, the plurality of weights, and the computation result being within a second threshold range less than the threshold range, change the original value within the second threshold range to one of a plurality of second representative values, and perform the neural network computation based on the changed value corresponding to the one of the plurality of second representative values.

Each of the plurality of first representative values and the plurality of second representative values may be a multiplier of 2, and the processor may be further configured to change any one or any combination of the input data, the plurality of weights and the computation result to a representative value having a smallest difference in size among the plurality of first representative values and the plurality of second representative values, and perform the neural network computation based on the representative value.

The processor may be further configured to obtain a multiplication computation result using one of the plurality of first representative values or the plurality of second representative values in a process of performing the neural network computation based on a shift operation.

The processor may be further configured to: obtain a number of bits below a threshold value determined based on the plurality of first representative values and the plurality of second representative values, and obtain the number of bits based on any one or any combination of the input data, the plurality of weights or the computation result not being within the threshold range, the first threshold range and the second threshold range.

The processor may be further configured to obtain the threshold range, the first threshold range, and the second threshold range based on the result of the neural network computation performed using the changed value, and the result of the neural network computation using the preset value.

The threshold range may be from −a to a, a may be a positive number, the first threshold range may be from b to c, the second threshold range may be from −c to −b, b may be a positive number greater than a and less than c, and c may be a positive number less than a maximum value of at least one of the input data, the plurality of weights, or the computation result obtained in the process of perfuming the neural network computation.

The threshold range may be different for each layer of the artificial intelligence model.

The electronic apparatus may further include a user interface. The processor may be further configured to, based on a user command being received through the user interface, identify whether any one or any combination of the input data, the plurality of weights, or the computation result is within the threshold range.

According to embodiments of the disclosure, a method for controlling an electronic apparatus that performs a neural network computation includes: performing the neural network computation with respect to input data based on a plurality of weights learned by an artificial intelligence model; identifying any one or any combination of the input data, the plurality of weights, and a computation result obtained in a process of performing the neural network computation being within a threshold range, changing an original value within the threshold range to a preset value; and performing the neural network computation based on the preset value.

The preset value may be 0.

The method may further include obtaining the threshold range based on a result of the neural network computation using the preset value and a result of the neural network computation performed using the original value.

### DESCRIPTION OF DRAWINGS

The above and other aspects, features, and advantages of certain embodiments of the present disclosure will be more apparent from the following description taken in conjunction with the accompanying drawings, in which:

FIG. 1A is a block diagram of an electronic apparatus;

FIG. 1B is a block diagram of a DLSR;

FIG. 1C illustrates a perceptron;

FIG. 1D is a block diagram of a hardware perceptron;

FIG. 2A is a block diagram illustrating a configuration of an electronic apparatus according to an embodiment;

FIG. 2B is a block diagram illustrating an example of a detailed configuration of an electronic apparatus;

FIGS. 3A and 3B illustrate a perceptron to which a mapper is added according to an embodiment;

FIG. 4 is a view illustrating a threshold range according to an embodiment;

FIG. 5 is a flowchart illustrating a mapping operation including an activation switch according to an embodiment;

FIG. 6 is a view illustrating a threshold range, a first threshold range, and a second threshold range according to an embodiment;

FIG. 7 is a flowchart illustrating a mapping operation including an activation switch in a plurality of threshold ranges according to an embodiment; and

FIG. 8 is a flowchart illustrating a method of controlling an electronic apparatus according to an embodiment of the disclosure.

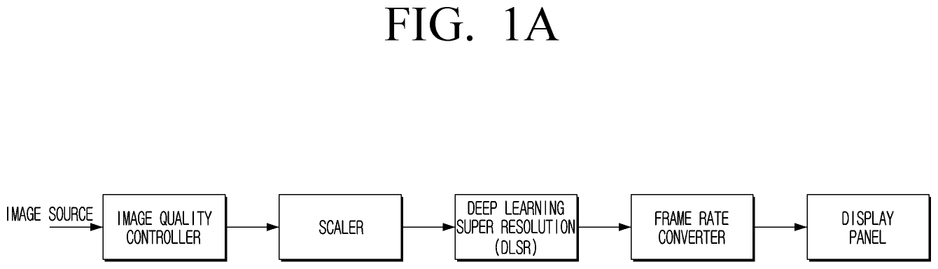

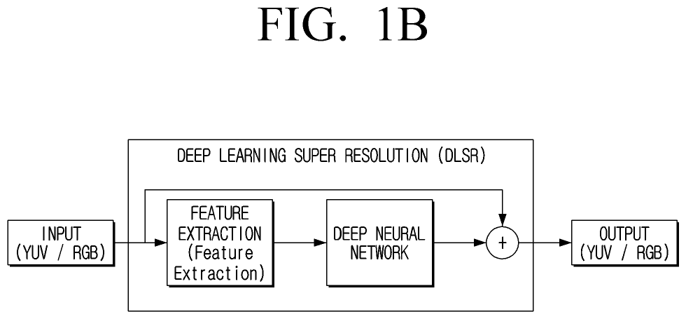

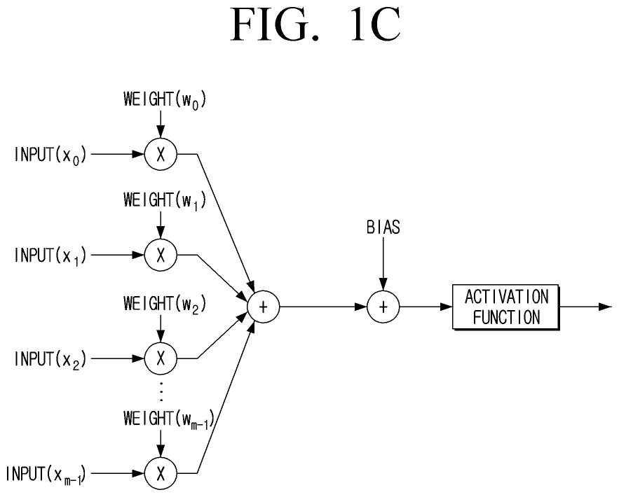

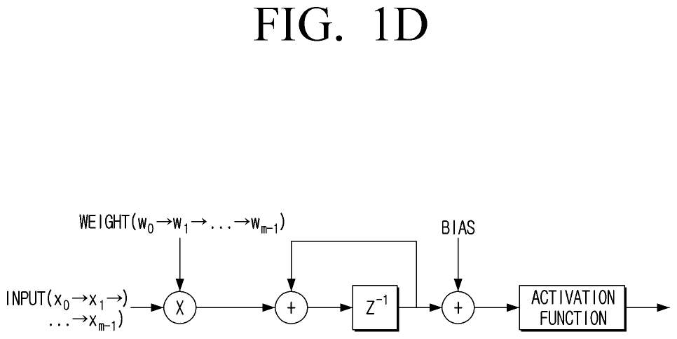

### MODE FOR INVENTION

Hereinafter, embodiments will be described with reference to the accompanying drawings.

The embodiments of the present disclosure may be diversely modified. Accordingly, specific embodiments are illustrated in the drawings and are described in detail in the detailed description. However, it is to be understood that the present disclosure is not limited to a specific embodiment, but includes all modifications, equivalents, and substitutions without departing from the scope and spirit of the present disclosure. Also, well-known functions or constructions are not described in detail since they would obscure the disclosure with unnecessary detail.

The disclosure is to provide an electronic apparatus for reducing power consumption generated in a neural network computation process, and a control method thereof.

Terms used in the disclosure are selected as general terminologies currently widely used in consideration of the configuration and functions of the disclosure, but can be different depending on intention of those skilled in the art, a precedent, appearance of new technologies, and the like. Further, in specific cases, terms may be arbitrarily selected. In this case, the meaning of the terms will be described in the description of the corresponding embodiments. Accordingly, the terms used in the description should not necessarily be construed as simple names of the terms, but be defined based on meanings of the terms and overall contents of the disclosure.

In the disclosure, expressions such as “have,” “may have,” “include,” or “may include” are used to indicate presence of components (e.g., numerical values, functions, operations, or part), and do not exclude additional features.

Expressions such as “at least one of,” when preceding a list of elements, modify the entire list of elements and do not modify the individual elements of the list. For example, the expression, “at least one of a, b, and c,” should be understood as including only a, only b, only c, both a and b, both a and c, both b and c, or all of a, b, and c.

The terms “1st” or “first” and “2nd” or “second” may use corresponding component regardless of importance or order and are used to distinguish a component from another without limiting the components.

Singular forms are intended to include plural forms unless the context clearly indicates otherwise. The terms “include”, “comprise”, “is configured to,” etc., of the description are used to indicate that there are features, numbers, steps, operations, elements, parts or combination thereof, and they should not exclude the possibilities of combination or addition of one or more features, numbers, steps, operations, elements, parts or a combination thereof.

Also, the term “user” may refer to a person who uses an electronic apparatus or an apparatus (e.g., an artificial intelligence (AI) electronic apparatus) that uses the electronic apparatus.

Hereinafter, embodiments will be described in greater detail with reference to the accompanying drawings.

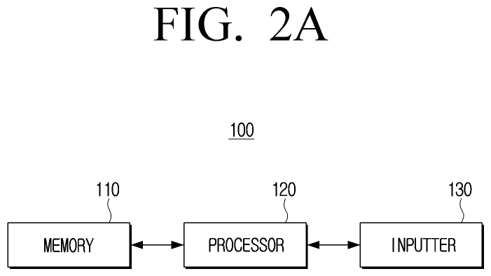

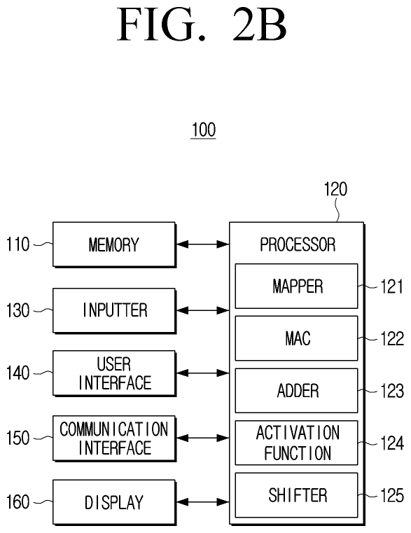

FIG. 2A is a block diagram illustrating an electronic apparatus 100 according to an embodiment.

The electronic apparatus 100 is a device that performs neural network computation, and includes a television (TV), a desktop personal computer (PC), a laptop computer, a smartphone, a tablet PC, a monitor, smart glasses, a smart watch, a set-top box (STB), a speaker, a computer body, and a video wall, a large format display (LFD), a digital signage (digital signage), a digital information display (DID), a projector display, a digital video disk (DVD) player, or the like. However, it is not limited thereto, and the electronic apparatus 100 may be any device as long as it is a device capable of performing a neural network computation.

Referring to FIG. 2A, the electronic apparatus 100 includes a memory 110, a processor 120, and an inputter 130. However, it is not limited thereto, and the electronic apparatus 100 may be implemented in a form excluding some components, or may further include other components.

The memory 110 may refer to hardware that stores information such as data in an electrical or magnetic form in order to allow the processor 120 or the like to access thereto. For this operation, the memory 110 may be implemented as at least one of a non-volatile memory, a volatile memory, a flash memory, a hard disk drive (HDD) or a solid state drive (SDD), RAM, ROM or the like.

Weights learned by the artificial intelligence model may be stored in the memory 110. Here, the artificial intelligence model may be convolutional neural network (CNN), deep neural network (DNN), recurrent neural network (RNN), restricted Boltzmann machine (RBM), deep belief network (DBN), bidirectional recurrent deep neural network (BRDNN), and deep Q-Networks, etc., and in the disclosure, weights learned by various types of artificial intelligence models as well as the aforementioned neural networks may be stored in the memory 110.

The artificial intelligence model may be learned through the electronic apparatus 100 or a separate server/system through various learning algorithms. The learning algorithm is a method in which a predetermined target device (e.g., a robot) is trained using a plurality of learning data such that the predetermined target device can make a decision or make a prediction by itself. Examples of learning algorithms may include supervised learning, unsupervised learning, semi-supervised learning, or reinforcement learning, and different learning algorithms may be used.

The memory 110 may store information on a threshold range and information on a preset value to which a value within the threshold range is to be converted. In addition, the memory 110 may store information on a plurality of threshold ranges and information on values to which values within each threshold range is to be converted. Information on such a threshold range may be different for each layer included in the artificial intelligence model.

The memory 110 may be accessed by the processor 120, and perform an instruction, a module, an artificial intelligence model, or readout, recording, correction, deletion, update, and the like, on data by the processor 120.

The inputter 130 may have any configuration for receiving input data. For example, the inputter 130 may be configured to receive input data through wired or wireless communication. Alternatively, the inputter 130 is a component that photographs an image like a camera, and the image may be input data.

The processor 120 controls a general operation of the electronic apparatus 100. Specifically, the processor 120 may be connected to each component of the electronic apparatus 100 to control the components of the electronic apparatus 100. For example, the processor 120 may be connected to a component such as a display to control the operation of the electronic apparatus 100.

According to an embodiment, the processor 120 may be implemented as a digital signal processor (DSP), a microprocessor, or a time controller (TCON), but is not limited thereto, and may include at least one of a central processing unit (CPU), microcontroller unit (MCU), micro processing unit (MPU), controller, application processor (AP), communication processor (CP), ARM processor, or may be defined with a corresponding term. In addition, the processor 120 may be implemented as a system on chip (SoC), a large scale integration (LSI) with a built-in processing algorithm, or a field programmable gate array (FPGA).

The processor 120 may perform a neural network computation on input data input through the inputter 130 based on the artificial intelligence model. Particularly, if at least one of an input data, a plurality of weights learned by the artificial intelligence model, or a computation result obtained in a process of performing a neural network operation is within a threshold range, the processor may perform a neural network operation by changing a value within the threshold range to a preset value.

For example, if at least one of the input data, the plurality of weights, or the computation result is within the threshold range, the processor 120 may perform a neural network computation by changing the value within the threshold range to 0.

Here, the threshold range may be obtained based on a result of a neural network computation performed using a changed value and a result of a neural network computation performed using a value before the change. For example, the threshold range may be set such that a peak signal-to-noise ratio (PSNR) of the result of the neural network operation performed using the changed value is maintained to be above a certain level of a peak signal-to-noise ratio of the result of the neural network operation performed using the value before the change.

The threshold range may be determined within a maximum and minimum range according to bits of input data, a plurality of weights, and a computation result. Also, the threshold range may be determined based on the number of bits of input data, a plurality of weights, or a computation result. For example, when the number of bits of input data, a plurality of weights, or a computation result is 16 bits, the threshold range may be determined from −16 to 16. Alternatively, when the number of bits of the input data, the plurality of weights, or the computation result is 8 bits, the threshold range may be determined from −4 to 4.

In addition, the threshold range may be different for each layer included in the artificial intelligence model. For example, the threshold range of the first layer included in the artificial intelligence model may be −4 to 4, and the threshold range of the second layer included in the artificial intelligence model may be −8 to 8.

If the input data, the plurality of weights, or computation results do not fall within the threshold range, the processor 120 may perform a neural network computation using the input data, the plurality of weights, or computation results as they are.

As described above, when the value within the threshold range is changed to 0, 0 may be output without the need of performing a multiplication computation or an addition operation, thereby reducing power consumption.

Additionally, when at least one of the input data, the plurality of weights, or the computation result is within a first threshold range greater than the threshold range, the processor 120 may change the value within the first threshold range to one of a plurality of first representative values, and when at least one of the data, the plurality of weights, or the computation result is within a second threshold range less than the threshold range, a value within the second threshold range may be changed to one of a plurality of second representative values to perform a neural network computation.

For example, if the number of bits of input data, plurality of weights, or computation results is 8 bits, the threshold range may be −4 to 4, the first threshold range may be 10 to 127, and the second threshold range may be −10 to −128.

Here, each of the plurality of first representative values and the plurality of second representative values is a multiplier of 2, and the processor 120 may convert at least one of the input data, the plurality of weights, or the computation results into a representative value having the smallest size difference between the plurality of first representative values and the plurality of second representative values.

In the description above, the plurality of first representative values nay be 16, 32, and 64, the plurality of second representative values may be −16, −32, −64, and −128, and if the weight or the computation result is 18, the processor 120 may change 18 to 16, and if it is 60, the processor may change 60 to 64 to perform the neural network computation.

In this case, the processor 120 may obtain a result of a multiplication computation using one of the plurality of first representative values or the plurality of second representative values in a process of performing the neural network operation based on a shift operation. In other words, since the plurality of first representative values or the plurality of second representative values are a multiplier of 2, the processor 120 may not perform a multiplication computation and may substitute the shift operation.

The processor 120 may include a multiplier capable of calculating a number of bits less than a threshold value determined based on the plurality of first representative values and the plurality of second representative values, and may obtain a multiplication computation result using multiplier when at least one of input data, a plurality of weights, or a computation result does not fall within the range, the first threshold range, and the second threshold range.

In the description above, if at least one of the input data, the plurality of weights, or the computation result is within the threshold range, the processor 120 may perform a neural network computation by changing a value within the threshold range to 0, and if at least one of the input data, the plurality of weights, or the computation result is within the first threshold range or the second threshold range, the processor may perform the shift operation using the corresponding value, and if the at least one of the input data, the plurality of weights, or the computation result does not fall within the threshold range, the processor may obtain a computation result using the multiplier or the adder.

In other words, the processor 120 may perform a computation only when at least one of input data, the plurality of weights, or the computation result does not fall within the threshold range, the first threshold range, and the second threshold range. In addition, as the embodiment described above, if the number of bits of the input data, the plurality of weights or the computation result is 8 bits, the processor 120 may need an 8-bit multiplier, but the 8-bit multiplier may not be required as the multiplication computation within the first threshold range and the second threshold range is replaced to the shift operation. In the description above, when input data, the plurality of weights, or computation results are within 5 to 9 and −5 to −9, a multiplication computation may be performed such that the processor 120 may only need a 4-bit multiplier.

The threshold range, the first threshold range, and the second threshold range may be obtained based on a result of a neural network computation performed using a changed value and a result of a neural network computation performed using a value before the change.

As described above, as some multiplication computations are replaced by shift operations, power consumption can be reduced. In addition, since the size of the multiplier may be reduced, hardware manufacturing costs may also be reduced.

FIG. 2B is a block diagram illustrating an example of a detailed configuration of the electronic apparatus 100. The electronic apparatus 100 may include a memory 110, a processor 120, and an inputter 130. In addition, referring to FIG. 2B, the electronic apparatus 100 may further include a user interface 140, a communication interface 150, and a display 160. Detailed descriptions of constitutional elements illustrated in FIG. 2A that are redundant with constitutional elements in FIG. 2B are omitted.

The user interface 140 may be implemented to be device such as button, touch pad, mouse and keyboard, or may be implemented to be touch screen that can also perform the function of the display. The button may include various types of buttons, such as a mechanical button, a touch pad, a wheel, etc., which are formed on the front, side, or rear of the exterior of a main body.

When a user command is received through the user interface 140, the processor 120 may identify whether at least one of input data, a plurality of weights, or computation results is within a threshold range. In other words, the processor 120 may perform a power saving operation only when there is a user command.

The communication interface 150 is a component for performing communication with various devices. For example, the communication interface 150 may support various wired communication methods such as HDMI, MHL, USB, RGB, D-SUB, DVI, or the like. In addition, the communication interface 150 may support various wireless communication methods such as Bluetooth (BT), Bluetooth Low Energy (BLE), Wireless Fidelity (WI-FI), Zigbee, or the like. However, it is not limited thereto, and any communication standard capable of communicating with an external device may be used.

The processor 120 may receive an image source from an external device through the communication interface 150 and may image-process the received image source.

The display 160 may be implemented as various types of displays, such as an Liquid Crystal Display (LCD), an Organic Light Emitting Diodes (OLED) display, and a Plasma Display Panel (PDP). The display 160 may include a driving circuit, a backlight unit, or the like which may be implemented in forms such as an a-si TFT, a low temperature poly silicon (LTPS) TFT, an organic TFT (OTFT), or the like. The display 160 may be realized as a touch screen, a flexible display, a 3-dimensional (3D) display, or the like.

The processor 120 may change a frame rate of the input data on which the neural network computation is performed through the artificial intelligence model and display it through the display 160.

Meanwhile, the processor 120 may include a mapper 121, a MAC 122, an adder 123, an activation function 124, and a shifter 125.

When at least one of input data, a plurality of weights, or computation results is within a specific range, the mapper 121 may change the corresponding value to another value.

The MAC 122 is a component for performing a convolution operation, and may multiply input data and weights and then accumulate them. The processor 120 may include a plurality of MACs to improve a speed of the convolution operation through parallel operation.

There may be a plurality of adders 123, and a first adder may add outputs of a plurality of MACs. A second adder may add an output and a bias of the first adder.

The activation function 124 is a configuration for performing operations such as Relu and Sigmoid, and may be implemented in various forms.

When at least one of the input data, a plurality of weights, or computation results is within the first threshold range or the second threshold range, the shifter 125 may change the corresponding value to a multiplier of 2 and replace the multiplication computation through a shift operation.

The above mapper 121, MAC 122, adder 123, activation function 124, and shifter 125 may be provided for each layer.

Meanwhile, in the above, a case of using the threshold range, the first threshold range, and the second threshold range has been described, but it not limited thereto. For example, the processor 120 may not use the threshold range, but may use only the first threshold range and the second threshold range. In addition, the processor 120 may use a method of changing the entire range to a multiplier of 2. In addition, the processor 120 may have a threshold range and a first threshold range adjacent to each other, and a threshold range and a second threshold range adjacent to each other. In this case, the processor 120 may not perform a multiplication computation.

Hereinafter, the operation of the processor 120 will be described in more detail through various drawings. In the following drawings, each embodiment may be implemented individually or may be implemented in a combined form.

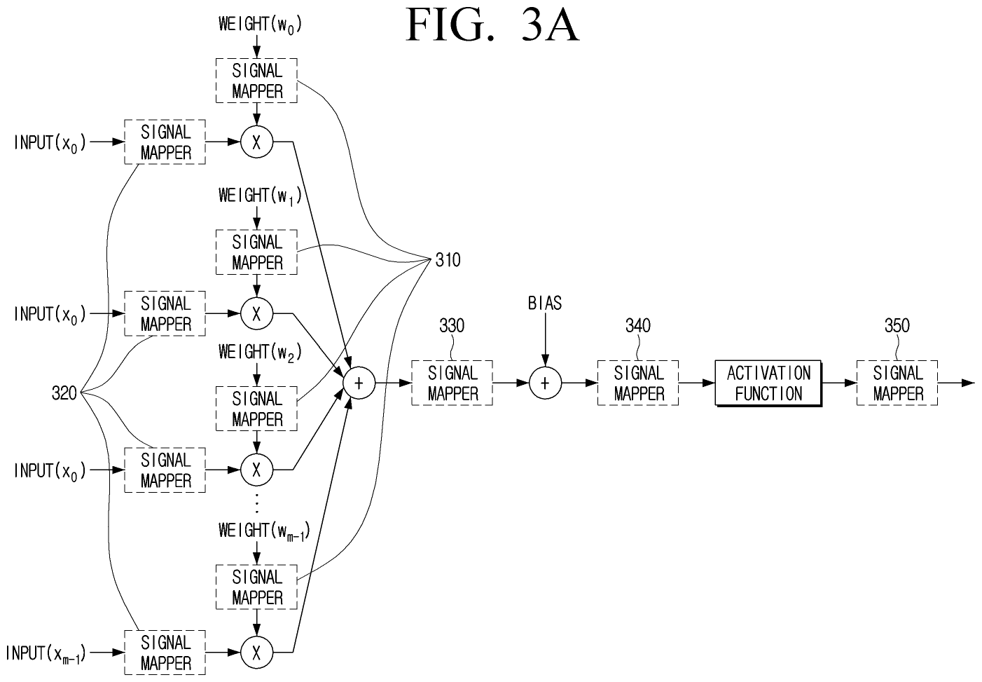

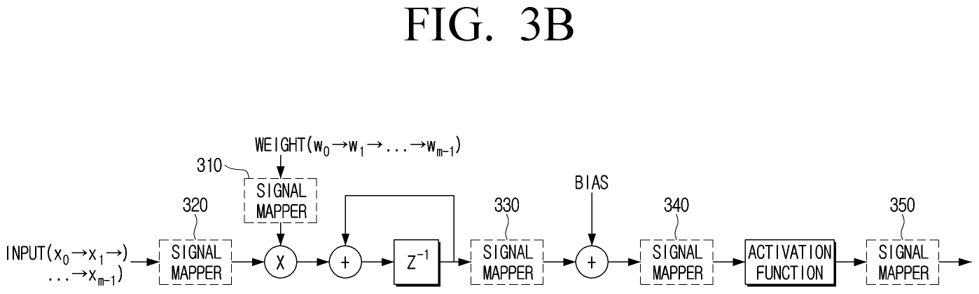

FIGS. 3A and 3B illustrate a perceptron to which a mapper is added according to an embodiment of the disclosure.

As shown in FIG. 3A, a first mapper 310 may identify whether a plurality of weights learned by the artificial intelligence model are within a specific range, and may change a weight within a specific range. Hereinafter, an operation of changing the weight will be described as a mapping operation.

A second mapper 320 may identify whether at least one of input data or feature map data acquired in a process of performing a neural network computation is within a specific range, and may change a value within the specific range.

A third mapper 330, a fourth mapper 340, and a fifth mapper 350 may each identify whether a computation result obtained in a process of performing a neural network computation is within a specific range, and may change an computation result value within a specific range.

Each mapper may operate according to user commands. For example, according to a user command, only the first mapper 310 may perform a mapping operation, and the remaining mappers may not perform the mapping operation. In addition, a specific range and a changed value of the first to fifth mappers 310 to 350 may be different from each other.

Also, in some cases, only some of the plurality of first mappers 310 may perform the mapping operation, and the remaining mappers among the plurality of first mappers 310 may not perform the mapping operation. In addition, a specific range and a value to be changed of the plurality of first mappers 310 may be different from each other.

If a perceptron of FIG. 3A is configured with a hardware structure in which a total of m input signals and weights are input, it may be illustrated as illustrated in FIG. 3B, and redundant descriptions are omitted.

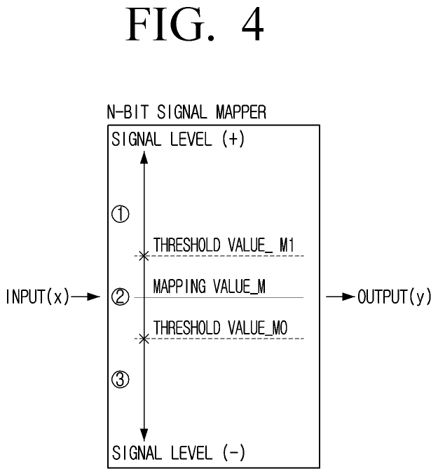

FIG. 4 is a view illustrating a threshold range according to an embodiment of the disclosure.

As shown in FIG. 4, if at least one of input data, a plurality of weights, or computation results is within a threshold value_M0 and a threshold value_M1, the processor 120 may change the corresponding value to a mapping value_M. In other words, if at least one of the input data, the plurality of weights, or computation results is within a section \textcircled{2}, the processor 120 may change the corresponding value to the mapping value_M, and if the mapping value_M is 0, the processor 120 may output 0 as a result of multiplication without doing multiplication and addition.

The processor 120 may perform a multiplication or addition operation without a mapping operation when at least one of input data, a plurality of weights, or computation results is within a section \textcircled{1} or \textcircled{3}.

Through the above operation, it is possible to reduce power consumption by minimizing the computation in section \textcircled{2}.

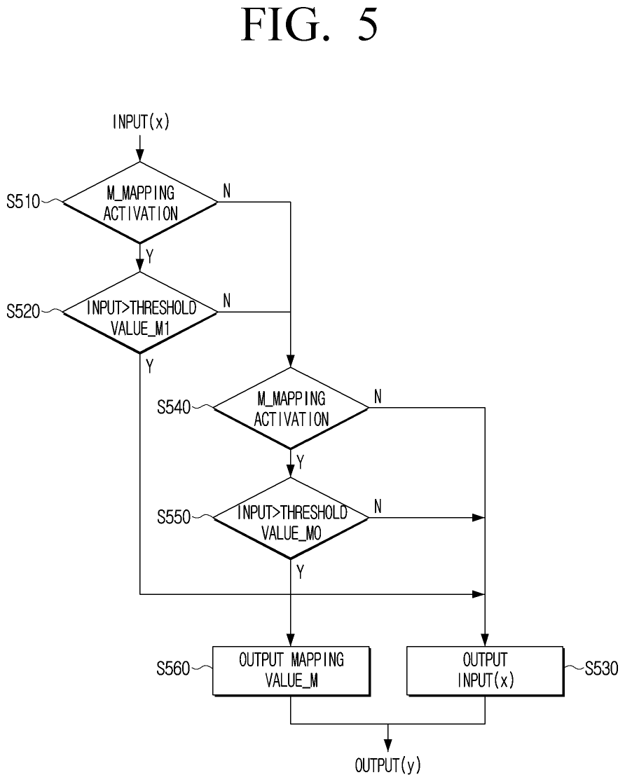

FIG. 5 is a flowchart illustrating a mapping operation including an activation switch according to an embodiment of the disclosure.

The processor 120 may identify whether the M_mapping activation switch is active (S510). In other words, if there is a user command, the processor 120 may identify that the M_mapping activation switch is activated and compare the input and the threshold value_M1 (S520).

As a result of the comparison, if the input is greater than the threshold value_M1, the processor 120 may output the input as it is without a mapping operation (S530).

Alternatively, if the M_mapping activation switch is not activated or a comparison result input is less than the threshold value_M1, the processor 120 may identify whether the M_mapping activation switch is activated (S540).

If the M_mapping activation switch is not activated, the processor 120 may output the input as it is (S530).

Alternatively, if the M_mapping activation switch is identified as being activated, the processor 120 may compare the input and the threshold value_M0 (S550). As a result of the comparison, if the input is less than the threshold value_M0, the processor 120 may output the input as it is without the mapping operation (S530).

Alternatively, if the input as a result of the comparison is greater than the threshold value_M1, the processor 120 may change the input to the mapping value_M and output it (S560).

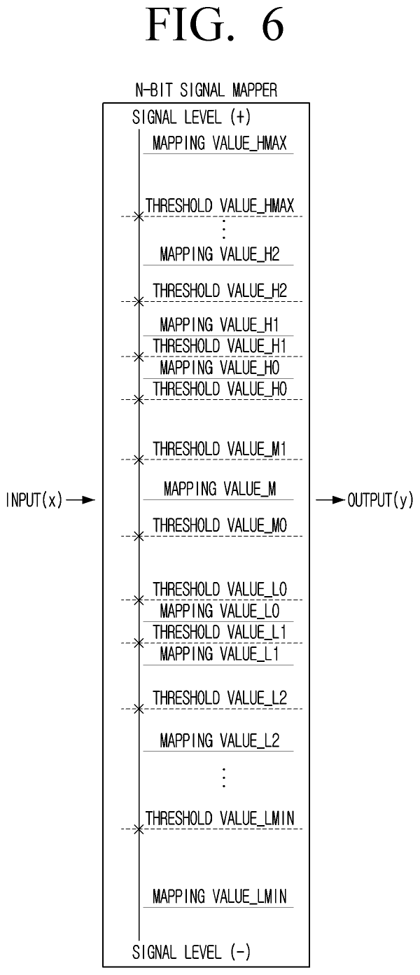

FIG. 6 is a view illustrating a threshold range, a first threshold range, and a second threshold range according to an embodiment of the disclosure. FIG. 6 is a concept including the threshold range of FIG. 4, and redundant descriptions are omitted.

As shown in FIG. 6, if at least one of input data, a plurality of weights, or an computation result is within a threshold value_H0 and a threshold value_Hmax, the processor 120 may change the corresponding value to one of a plurality of first representative values, and if at least one of the input data, the plurality of weights, or the computation result is within a threshold value_L0 and a threshold value_Lmin, the processor 120 may change the corresponding value may to one of a plurality of second representative values.

In other words, the first threshold range may be within the threshold value_H0 and the threshold value_Hmax, and the second threshold range may be within the threshold value_L0 and the threshold value_Lmin. The first threshold range and the second threshold range are described based on the first threshold range with a similar concept.

The plurality of first representative values (mapping value_H0 to mapping value_Hmax) may be a multiplier of 2 within the first threshold range. In addition, there are a plurality of sections within the first threshold range, and a boundary of the plurality of sections may be an intermediate value of adjacent mapping values.

The processor 120 may change at least one of the input data, the plurality of weights, or the computation result to a corresponding mapping value by sequentially comparing at least one of the input data, the plurality of weights, or the computation result with threshold values.

When at least one of the input data, the plurality of weights, or the computation results falls within the first threshold range or the second threshold range, the processor 120 may perform a mapping operation and obtain a multiplication computation result through a shift operation.

Meanwhile, if at least one of the input data, the plurality of weights, or the computation result does not fall within the threshold range, the first threshold range, and the second threshold range, the processor 120 may perform a multiplication computation without performing a mapping operation.

As described above, power consumption may be reduced through the shift operation, and the multiplier may be miniaturized by reducing effective bits of the multiplication computation.

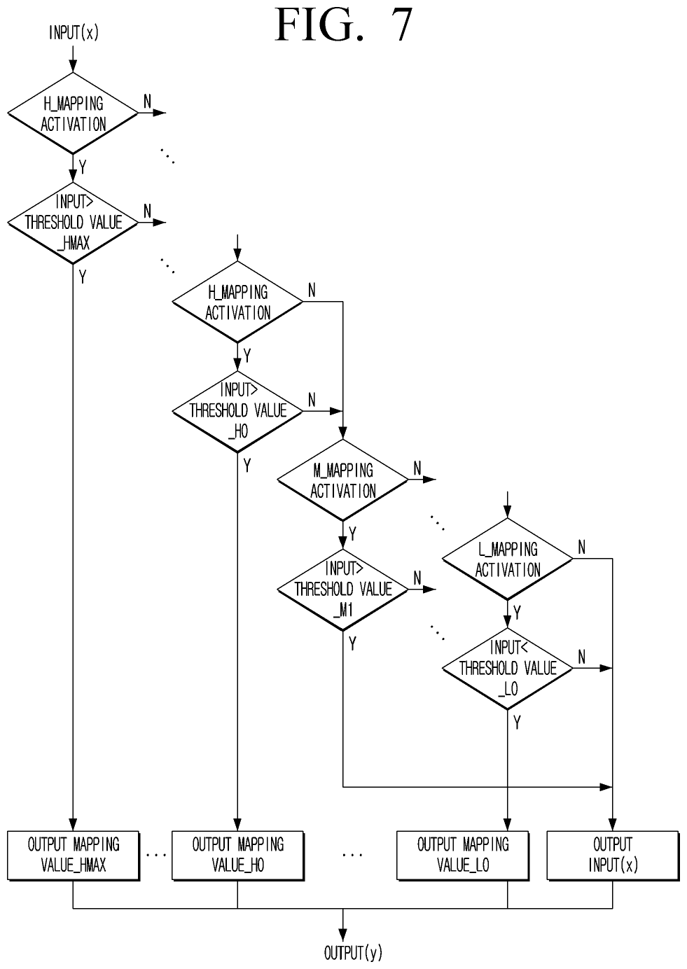

FIG. 7 is a flowchart illustrating a mapping operation including an activation switch in a plurality of threshold ranges according to an embodiment of the disclosure.

As illustrated in FIG. 7, the processor 120 may perform a mapping operation based on an activation switch operation and a comparison operation with a plurality of threshold ranges. The processor is merely describing the operation of FIG. 5 in more detail, and redundant descriptions are omitted.

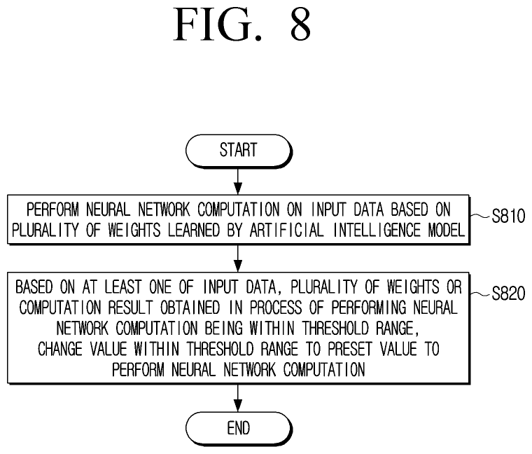

FIG. 8 is a flowchart illustrating a method of controlling an electronic apparatus according to an embodiment of the disclosure.

A neural network computation on input data may be performed based on an artificial intelligence model (S810). And, if at least one of input data, a plurality of weights learned by an artificial intelligence model, or a computation result obtained in a process of performing a neural network computation is within a threshold range, a value within a threshold range may be changed to a preset value to perform the neural network computation (S820).

In an operation of performing the neural network computation by changing (S820), if at least one of the input data, the plurality of weights, or the computation result is within a threshold range, a value within the threshold range may be changed to 0 to perform the neural network computation.

Here, the threshold range may be obtained based on a result of a neural network computation performed using a changed value and a result of a neural network computation performed using a value before the change.

Alternatively, in an operation of performing the neural network computation by changing (S820), if at least one of the input data, the plurality of weights, or the computation result is within a first threshold range greater than the threshold range, a value within the first threshold range may be changed to one of the plurality of first representative values, and if at least one of the input data, the plurality of weights, or the computation result is within a second threshold range less than the threshold range, a value within the second threshold range may be changed to one of the plurality of second representative values to perform the neural network computation.

Here, each of the plurality of first representative values and the plurality of second representative values is a multiplier of 2, and the operation of changing and performing the neural network computation (S820) may change at least one of the input data, the plurality of weights, or the computation result to a representative value having the smallest difference in size among a plurality of first representative values and a plurality of second representative values, and perform the neural network computation.

The operation of changing and performing the neural network computation (S820) may obtain a multiplication computation result using one of the plurality of first representative values or the plurality of second representative values in the process of performing the neural network computation based on the shift operation.

Meanwhile, in the operation of performing a neural network computation on the input data (S810), if at least one of the input data, the plurality of weights, or the computation result does not fall within the threshold range, a multiplication operation result is obtained using a multiplier, and the multiplier may perform a number of bits less than a threshold value determined based on a plurality of first representative values and a plurality of second representative values.

The threshold range, the first threshold range, and the second threshold range may be obtained based on a result of a neural network computation performed using a changed value and a result of a neural network computation performed using a value before the change.

In addition, the threshold range may be different for each layer included in the artificial intelligence model.

Meanwhile, the operation of receiving a user command is further included, and the operation of changing and performing a neural network computation (S820) is to identify whether at least one of input data, a plurality of weights, or computation results is within a threshold range when the user command is received.

According to various embodiments of the disclosure as described above, the electronic apparatus may reduce power consumption by changing some of input data, the plurality of weights learned by the artificial intelligence model, or computation results obtained in a process of performing a neural network computation to a preset value.

In addition, the electronic apparatus may reduce power consumption by replacing some of a plurality of multiplication computations with a shift operation in the process of performing a neural network computation.

In addition, as some of the plurality of multiplication computations are replaced by shift operations, the size of the multiplier may be reduced, thereby reducing manufacturing cost.

According to an embodiment, the various embodiments described above may be implemented as software including instructions stored in a machine-readable storage media which is readable by a machine (e.g., a computer). The device may include the electronic device (e.g., an electronic device (A)) according to the disclosed embodiments, as a device which calls the stored instructions from the storage media and which is operable according to the called instructions. When the instructions are executed by a processor, the processor may directory perform functions corresponding to the instructions using other components or the functions may be performed under a control of the processor. The instructions may include code generated or executed by a compiler or an interpreter. The machine-readable storage media may be provided in a form of a non-transitory storage media. The ‘non-transitory’ means that the storage media does not include a signal and is tangible, but does not distinguish whether data is stored semi-permanently or temporarily in the storage media.

In addition, according to an embodiment, the methods according to various embodiments described above may be provided as a part of a computer program product. The computer program product may be traded between a seller and a buyer. The computer program product may be distributed in a form of the machine-readable storage media (e.g., compact disc read only memory (CD-ROM) or distributed online through an application store (e.g., PlayStore™). In a case of the online distribution, at least a portion of the computer program product may be at least temporarily stored or provisionally generated on the storage media such as a manufacturer's server, the application store's server, or a memory in a relay server.

Further, each of the components (e.g., modules or programs) according to the various embodiments described above may be composed of a single entity or a plurality of entities, and some subcomponents of the above-mentioned subcomponents may be omitted or the other subcomponents may be further included to the various embodiments. Generally, or additionally, some components (e.g., modules or programs) may be integrated into a single entity to perform the same or similar functions performed by each respective component prior to integration. Operations performed by a module, a program module, or other component, according to various embodiments, may be sequential, parallel, or both, executed iteratively or heuristically, or at least some operations may be performed in a different order, omitted, or other operations may be added.

While embodiments have been particularly shown and described, it will be understood that various changes in form and details may be made therein without departing from the spirit and scope of the following claims.

What is claimed is:

1. An electronic apparatus comprising:
an input interface;
a memory configured to store a plurality of weights corresponding to an artificial intelligence model; and
a processor configured to perform a neural network computation with respect to input data provided through the input interface based on the plurality of weights,
wherein the processor is configured to, based on any one or any combination of the input data, the plurality of weights, and a computation result obtained in a process of performing the neural network computation being within a threshold range, change an original value within the threshold range to a preset value and perform the neural network computation based on the preset value.

2. The electronic apparatus of claim 1, wherein the preset value is 0.

3. The electronic apparatus of claim 2, wherein the processor is further configured to obtain the threshold range based on a result of the neural network computation using the preset value and a result of the neural network computation performed using the original value.

4. The electronic apparatus of claim 1, wherein the threshold range is within a range from −a to a, and
wherein a is a positive number less than a maximum value of at least one of the input data, the plurality of weights, or the computation result obtained in a process of performing the neural network computation.

5. The electronic apparatus of claim 1, wherein the processor is further configured to:
based on any one or any combination of the input data, the plurality of weights, and the computation result being within a first threshold range greater than the threshold range, change the original value within the first threshold range to one of a plurality of first representative values, and perform the neural network computation based on a changed value corresponding to the one of the plurality of first representative values, and
based on any one or any combination of the input data, the plurality of weights, and the computation result being within a second threshold range less than the threshold range, change the original value within the second threshold range to one of a plurality of second representative values, and perform the neural network computation based on the changed value corresponding to the one of the plurality of second representative values.

6. The electronic apparatus of claim 5, wherein each of the plurality of first representative values and the plurality of second representative values is a multiplier of 2, and
wherein the processor is further configured to change any one or any combination of the input data, the plurality of weights and the computation result to a representative value having a smallest difference in size among the plurality of first representative values and the plurality of second representative values, and perform the neural network computation based on the representative value.

7. The electronic apparatus of claim 6, wherein the processor is further configured to obtain a multiplication computation result using one of the plurality of first representative values or the plurality of second representative values in a process of performing the neural network computation based on a shift operation.

8. The electronic apparatus of claim 5, wherein the processor is further configured to:
obtain a number of bits below a threshold value determined based on the plurality of first representative values and the plurality of second representative values, and
obtain the number of bits based on any one or any combination of the input data, the plurality of weights or the computation result not being within the threshold range, the first threshold range and the second threshold range.

9. The electronic apparatus of claim 5, wherein the processor is further configured to obtain the threshold range, the first threshold range, and the second threshold range based on the result of the neural network computation performed using the changed value, and the result of the neural network computation using the preset value.

10. The electronic apparatus of claim 5, wherein the threshold range is from −a to a,
wherein a is a positive number,
wherein the first threshold range is from b to c,
wherein the second threshold range is from −c to −b,
wherein b is a positive number greater than a and less than c, and
wherein c is a positive number less than a maximum value of at least one of the input data, the plurality of weights, or the computation result obtained in the process of perfuming the neural network computation.

11. The electronic apparatus of claim 1, wherein the threshold range is different for each layer of the artificial intelligence model.

12. The electronic apparatus of claim 1, further comprising a user interface,
wherein the processor is further configured to, based on a user command being received through the user interface, identify whether any one or any combination of the input data, the plurality of weights, or the computation result is within the threshold range.

13. A method for controlling an electronic apparatus that performs a neural network computation, the method comprising:
performing the neural network computation with respect to input data based on a plurality of weights learned by an artificial intelligence model;
identifying any one or any combination of the input data, the plurality of weights, and a computation result obtained in a process of performing the neural network computation being within a threshold range, changing an original value within the threshold range to a preset value; and
performing the neural network computation based on the preset value.

14. The method of claim 13, wherein the preset value is 0.

15. The method of claim 14, further comprising obtaining the threshold range based on a result of the neural network computation using the preset value and a result of the neural network computation performed using the original value.
